(19) United States
(12) Patent Application Publication
(10) Pub. No.: US 2013/0201162 A1
(43) Pub. Date: Aug. 8, 2013

(54) MULTI-PURPOSE PEN INPUT DEVICE FOR USE WITH MOBILE COMPUTERS

(71) Applicant: Ian Daniel Cavilia, Glastonbury, CT (US)

(72) Inventor: Ian Daniel Cavilia, Glastonbury, CT (US)

(21) Appl. No.: 13/366,354

(22) Filed: Feb. 5, 2012

(51) Int. Cl. G06F 3/033

(52) U.S. Cl. 345/179

(57) ABSTRACT

A compact, hand-held, pen-like multi-functional peripheral device to be used with mobile computers such as smartphones and tablets. The unit communicates with the host device wirelessly via the bluetooth protocol. The unit can be stored inside the host device's hardware where its lithium-ion battery can conveniently be re-charged.

### FIELD OF THE INVENTION

The present invention relates generally to the field of portable, hand-held computing devices. More particularly, the invention is a pen-like peripheral whose multiple components make it capable of a large variety of functions.

### BACKGROUND

The history of the modern-day stylus begins with the advent of personal digital assistants, for example Apple's Newton and Palm's Pilot. The stylus was basically a “dumb stick with a fine point” that the resistive-input touchscreen technology of the time made necessary and desirable. Resistive-input screens require the application of force sufficient to physically distort the outer layer of the screen. The design of the graphical user interface (GUI) also warranted the use of a fine-point tool. The GUI was basically adapted from that used on desktop operating systems which were designed to be used with a mouse. The GUI controls were small and closely spaced, requiring a small object to pinpoint them. The stylus was small enough to target such objects as was the mouse cursor, but not the finger. Writing, drawing, or pushing small buttons require that force to be limited to a specific and rather small area of the screen. One's fingertip would be too fat. The slender stylus with a fine point was the right tool.

Special handwriting recognition programs were developed to permit users to input text and to search terms using a variant of natural, cursive writing. These programs were awkward and rather than being able to write naturally the user was required to learn a distinctive and not particularly natural penmanship style in order to communicate with the device.

The development of the capacitive touchscreen made the “dumb stylus” unnecessary. Capacitive screens don't require as much force as resistive, making them easier to operate with the finger. They have become true “touch” screens instead of “push”screens. Using less force meant less friction, making it easier to glide fingers across the screen. This has given rise to new intuitive user interface (UI) concepts such as kinetic scrolling and gesture-based actions. Finger-friendly GUIs required larger widgets but the increase in screen size has made this possible. The stylus seemed increasingly unattractive when it was no longer necessary for everyday interactions. The few activities that benefit from it, such as drawing and handwriting, didn't justify the inclusion of one.

Apple's iPhone, and later the iPad (though they were not alone) heralded the new dominance of stylus-free mobile computing devices. These devices, with their clever interfaces, provide tremendous functionality with finger-touch screens. Since then most device manufacturers have followed suit. The mobile operating systems that were designed for stylus input, namely PalmOS and Windows Mobile, have been discontinued by their developers and new platforms such as Android have arisen around finger interaction, adopting many of the concepts pioneered by Apple's platform.

Product developers and inventors, taking advantage of increases in the miniaturization of components like cameras and accelerometers, have continued to explore the possibilities of pen-like computing devices. “Smart pens” have been developed whose intention is to provide computer input while the pen writes on a surface other than the computer's touch screen . Some rely on motion sensors within the pen to accurately determine the pen's position and motion so that it may be translated into text through handwriting recognition software. Others, more successfully, require special paper that has a printed background pattern. A camera in the tip of the pen acquires an image of both the marks written with the pen and the background pattern of the special paper, which permits the pen's computer processor to determine its precise location on the page.

Stylus designs optimized for the now ubiquitous capacitive touchscreens have recently been developed. The inherent low input resolution of this screen technology will likely mean the stylus provides minimally more precise input than a fingertip and thus provides little incentive for its adoption.

Other stylus developments take advantage of the “active digitizer” touchscreen technology, in which elements in the screen interact with the stylus tip via electromagnetic fields, permitting finer resolution than the capacitive screen. These have been confined largely to dedicated drawing pads (rather than display screens), though a few tablet computers and smart phones have employed them, with limited success.

All of these applications of stylus technology are still single-purpose devices for computer input. None provide sufficient advantage to overcome the now deeply-ingrained consumer resistance to the use of a separate peripheral with a hand-held device. Although some smart pens and styli have incorporated cameras and accelerometers, they use these components only to provide pen location data—i.e., only to aid the basic input function of the stylus as a pen.

No development of the stylus has employed these components—the camera and the accelerometer—to make the stylus a true multi-function peripheral. Such expanded capabilities would provide an incentive for the consumer to choose a stylus-equipped mobile computer. The present invention addresses this gap, providing a stylus that is really a multi-functional external device. It allows the fine-grained and flexible inputs of a smart stylus, thus turning the mobile computer into a powerful graphics pad, but it is far more, with the camera, light, microphone, speaker, temperature sensor and accelerometer permitting a large number of functions that mobile computers are presently incapable of, or cannot perform conveniently.

### SUMMARY OF THE INVENTION

The invention is a stylus or pen-like device that looks and feels very much like a conventional writing instrument. For example, on one end there is a tip for writing or drawing and on the opposite end there is a functional electronic eraser. As with many conventional pens, the device has a clip that allows the device to be affixed to items such as clothing, or the shoulder harness of an automobile's seatbelt.

The embodiment described in detail below includes all of the proposed components. Other embodiments of the invention may omit one or more of the components, in order to reduce cost, size and complexity if that is what a computer maker desires for a particular application.

The device fits into a dedicated space within the outer shell of the host device (smartphone or tablet computer) where its lithium-ion battery can be recharged. It communicates with the host device via the bluetooth wireless protocol.

The size of the device may vary. The functions desired will dictate the components required. Since the device is intended to be stored within its host's hardware, this will dictate, to some degree, the number of components that can be included. A smartphone will accommodate the least number, while a tablet computer would have the capacity for more. The smartphone would require a slenderer version. A tablet computer could adopt a slender version, if desired, or a larger diameter version, if preferred. The range in diameter and size is roughly that between a common stick pen and a pre-schooler's crayon.

The device is multi-functional, going far beyond the capabilities of a simple pen. It can be used to write, draw, create shading effects in drawings, erase completely or in part, take photos, take videos, make and receive phone calls hands-free, record voice memos, operate GUI controls, play games, make voice commands, scan bar codes, scan text, measure body temperature, send images for remote medical diagnosis, and as a remote pointer for power point presentations.

It achieves these functionalities by way of its many and uniquely-configured components: a digitizer tip (1), a camera sensor (2), camera lights (3), an accelerometer (4), a microphone (5), an eraser/lightguide structure (6), a camera lens (7), a speaker (8), a vibrator (9), an LED ring (10), a display (11), a temperature sensor (12), one or more buttons (13), a lithium-ion battery (14), a bluetooth module (15), and a clip (16).

By means of a spring-loaded retracting tip, the stylus is pressure-sensitive, which allows the graphics software to respond as if the user were using a physical pen or brush in which the character of the line is varied when the user applies varying pressure. For example, if the software is configured to act as a soft pencil or charcoal, increased pressure would result in a darker line. If the graphics program were configured to act like a brush, light pressure would provide a fine, thin line, while increased pressure would result in a wider line, as if a brush's bristles were being spread by increased pressure.

The opposite end of the unit contains both a camera and a ring-shaped structure that is spring-retractable in a manner similar to the pen nib, and can act as an eraser, or for other functions. The camera is mounted in the center of the ring. The ring also acts as a light guide for one or more LEDs at its base. This can provide, when necessary, flash for the camera and a steady light for video. Buttons are located at various points on the device, for additional actions in conjunction with each component's function, and for functions performed by combinations of various components.

### BRIEF DESCRIPTION OF THE DRAWINGS

FIG. 1 shows a side view of the embodiment of the device that includes all of the possible components.

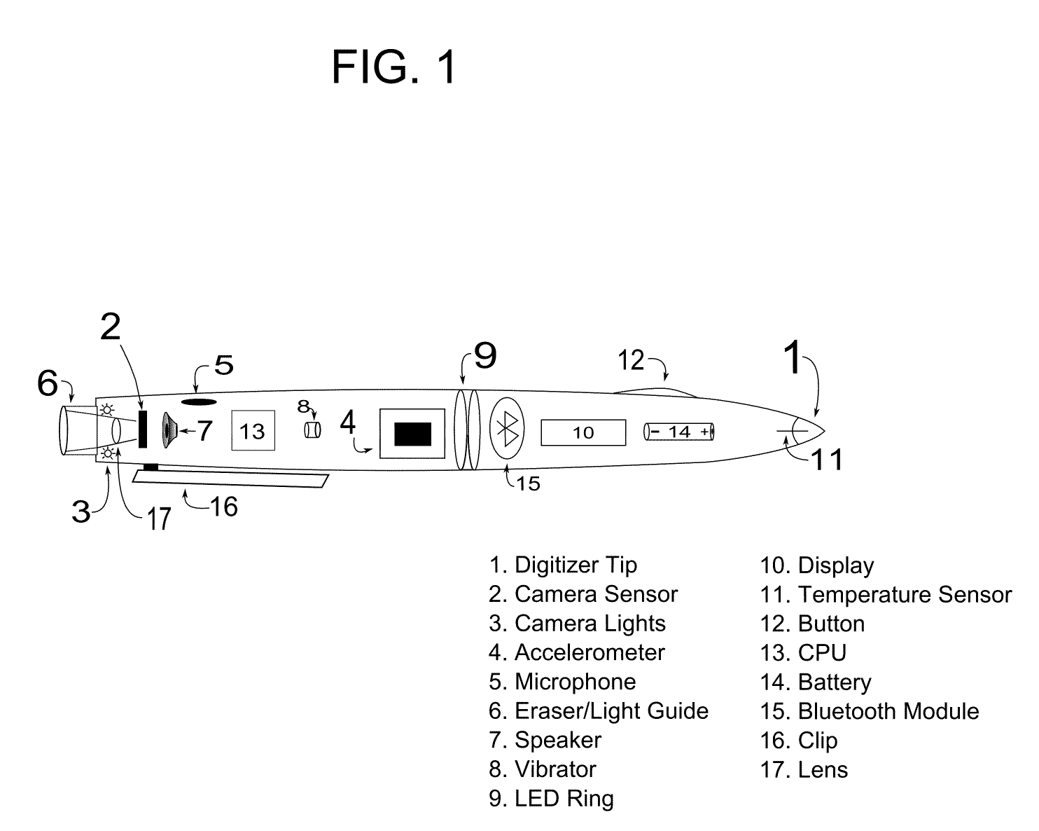

FIG. 2 shows the camera eraser combo illustrating the path of light from the camera light.

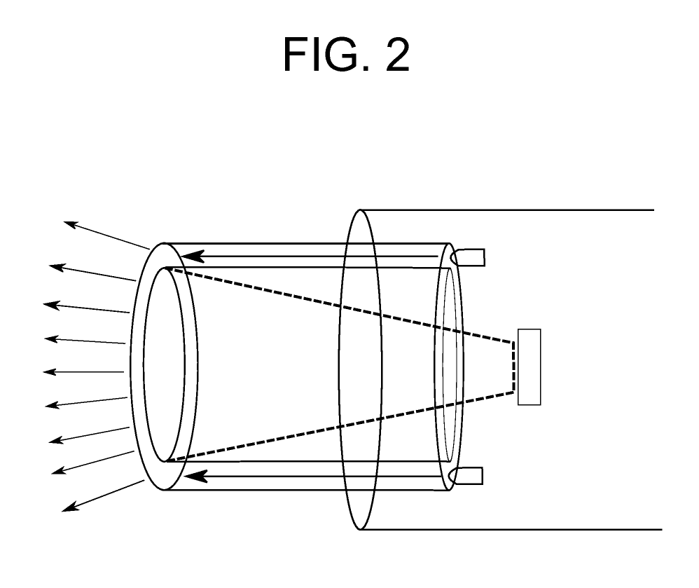

FIG. 3 shows the camera end pointing at the screen using the pointer function.

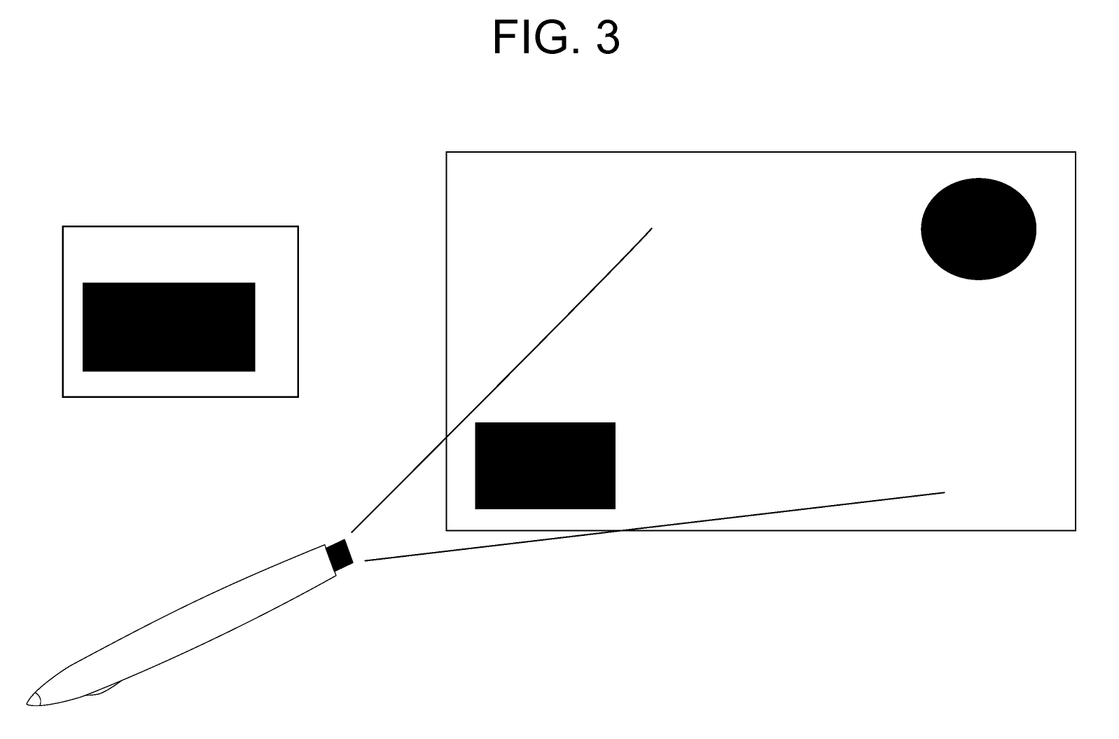

### DETAILED DESCRIPTION

The present invention is a peripheral device that adds significant functionality to mobile computing devices easily and conveniently. It has the appearance of a conventional writing instrument and its components are arranged in a manner that reinforces this similarity, in order to provide the user with a device that feels like a pen or pencil. By incorporating multiple components, significant functionality is achieved.

The embodiment described herein incorporates all of the components contemplated by the inventor. However, the device would be functional and useful while omitting one or more of the components. While any such omissions would of course reduce the functionality of the device, a manufacturer could reasonably choose to manufacture versions of the device with such omissions, in order to reduce the size, cost and complexity of the device. This might be the case, for example, if the device were to be used with a smaller-platform phone, or with a portable computer aimed at a lower price point. The present invention encompasses all embodiments that omit one or more of the components discussed in this detailed description.

The pen function employs an active digitizer tip that interacts with the digitizer matrix under the screen. The coil in the pen tip generates a magnetic field which induces currents in the coils behind the display when brought into proximity. The coils are arranged in rows and columns which intersect. The coils in one set form rows which run the width of the screen, while the other set forms columns perpendicular to those running the height of the screen. This results in a grid of intersections between these coils. The pen induces currents into two coils at an intersection. The digitizer circuit determines the position of the pen by which coils are receiving its signal. When the tip of the pen is pressed against the surface of the screen, the nib is pushed inward, which triggers a switch inputting the amount of displacement into the circuits in the pen. This data is then transmitted to the device by modulating the magnetic field generated by it, which is interpreted by the host software. The amount of displacement of the nib is analogous to the amount of force applied to the pen against the screen. This quantity is relayed to the host, enabling the software to sense the pressure and manipulate parameters such as line width or opacity. The active pen tip, used to activate the digitizer in the computer screen, is existing technology, already in use in graphics tablets and in some tablet computers.

Input can be customized. For example, the line drawn could be made to appear thick or thin, to appear in different colors, or to include shading or brush-stroke effects. Switches on the pen device unit, as well as buttons on the host device's screen, allow these options to be selected easily by the user.

The active pen tip is spring-loaded and retractable. This allows it to sense the degree of pressure being exerted by the user on the surface of the touchscreen. When this information is transmitted from the pen to the computer, the software can cause a line to be lighter or darker, narrower or wider, as desired, as is possible with conventional drawing instruments.

The input/display screen of the host device will be constructed with both capacitive-touch and active-digitizer functionality. This will allow the user maximum flexibility to chose the most appropriate or convenient tool: the active pen tip or the tip of one's finger.

Another embodiment of the invention uses a simple tip usable types of screens, such as resistive and capacitive, if a manufacture chose to adapt the device to a mobile computer that employs those screen technologies.

One of the pen's components is an accelerometer. The accelerometer can detect the angle at which the pen is held with respect to the horizon. By comparing that measurement to a similar reading from the accelerometer in the host device (smartphone or tablet), the pen-to-screen angle can be computed, and changes in that angle can be applied to modify the input of the pen-point to mimic the action of a conventional artist's brush or a pen nib. For example, when programmed to behave like a tapered brush, tilting the pen would cause the impression to widen as if paint were being applied. If programmed to behave like artist's charcoal or pastel, the tilt of the angle would create a broader line.

The accelerometer function in combination with the penpoint's pressure sensitivity can provide an artist with a virtual portable box of art supplies: brushes, pens, pencils, charcoal, pastels and paint. These virtual tools are easily and, most importantly, intuitively controllable.

These graphics capabilities would not just benefit the next Picasso but would be of use to engineers, graphic artists, interior designers and architects. One of these professionals could quickly sketch and transmit a drawing to a colleague or client while on the phone. A photograph, taken by the host device or by the peripheral, or sent by another party to the conversation, could be quickly and easily labeled, or tagged with explanatory information, and then returned or forwarded.

The small size of the smartphone's screen is a minor limitation. Software controls will allow zooming in on any portion of the drawing. This will permit any level of detail to be drawn or “painted.”

The eraser is an active tip (as opposed to a passive tip) located at the bottom end of the device, where it is customary to find a pencil's eraser. The operation of the eraser is the same as that of the pen tip. A coil near the eraser end transmits magnetic fields to the coils under the screen, except that it sends a different code indicating to the host that it is the eraser and not the tip. The eraser, like the tip, presses inward when forced against the screen to convey the amount of pressure. Its operation is intuitive: the user simply presses on any part of the edge of the transparent plastic ring, in much the same way one does with a conventional pencil eraser.

The camera is coaxially positioned inside the center of the eraser. This positioning method allows the two components to occupy the limited space on the rear end of the pen without compromising the operation of either one. The rear face of the eraser is a cone-shaped recess with the lens at the bottom. This protects the lens from abrasion by contact with surfaces without the necessity for a removable and easily lost protective cover. The rim of this recess is the only surface that comes into contact with the screen when using the eraser. The camera sensor is of the CMOS (complementary metal oxide semiconductor) type and is located inside the pen, below the lens. An autofocus mechanism may be used to allow the camera to focus at a variety of distances. The video signal from the camera is converted to digital by an analog-to-digital converter and compressed by the microprocessor, then transmitted to the host device via the bluetooth link. Application software on the host device can access this video stream and perform various actions on it, including capture of still images, capture of motion video, and processing of the live stream. The microphone can be used to record audio when capturing video.

The camera is also supplemented by a light that assists visibility in the dark, similar to a camera flash or video light. The way the light is placed makes use of the limited area of the rear end of the pen and provides illumination from all points around the lens instead of at a single point like most flashes. The light source is one or more white LEDs located in the rear of the pen beneath the eraser. The outer barrel of the eraser is comprised of a light transmitting material constructed in such a way as to promote total internal reflection. Light from the LEDs travels through the walls of the barrel along the longitudinal axis, emanating from the outer rim. Thus a ring of light glows from all points surrounding the camera, providing even illumination even at extreme close-up range. The outer surface of the barrel is painted with an opaque finish to minimize light loss.

The uses of the camera are basically an extension of those that can be achieved with cameras already built into phones. The advantages however are greater maneuverability thanks to a smaller device. The camera can be used to take pictures and video just like the built-in ones, but can take close-up shots in places that are too small to fit the large phone into. Examples include close-up shots of plants and insects. It can also be used to inspect in hard to reach locations by viewing live video on the phone's screen without recording images. Such examples include looking under a couch or behind furniture and inspecting inside the mouth or ears or looking inside machinery being repaired or constructed. The camera can also be used to scan barcodes and QR (quick response) codes just like the ones on phones except here the maneuverability is advantageous.

Another use of the camera is as a remote pointing device. When used with a larger screen, the camera end can be pointed at the screen and moved to position a cursor and click GUI widgets like a mouse. This interaction is much like that on Nintendo's Wii console except without placing any accessory near the screen. The camera captures an image of the screen and relays it to the device. The software compares the image seen by the camera to what is currently being displayed. By knowing the location of the object in focus on the plane of the screen, the software knows the position on the screen where it is pointing. Remote pointing is best suited to larger screens such as propping up a tablet-sized device or connecting the device to a television set or computer monitor. It requires no sensors in the screen and thus is compatible with all display devices currently on the market.

The microphone is of the condenser type typically found on consumer electronics. These microphones can be made compact enough to fit inside the pen in a variety of locations. One sensible location would be inside the rear end behind the eraser/camera combo. Sound enters through the narrow space between the eraser and the outer shell. This configuration enables the user to speak into the end of the pen as if it were a typical handheld microphone. The signal from the microphone is converted to digital by an analog-to-digital converter and transmitted to the host via the bluetooth link. Uses for the microphone are mostly the same as those that can be performed with the built-in microphone with the advantages of a smaller device. It can be used to record ambient sounds with the ability to point it in up-close locations. When recording video with the camera it can capture sound accompanying it from the same point of view as the camera. The microphone can also be used to issue voice commands and make voice calls (supplemented by the speaker).

The speaker may be located anywhere in the pen. The audio signal is transmitted from the host device via the bluetooth link and converted to analog signal, then amplified and fed to the speaker. The functions of the speaker on the pen are somewhat different from those performed by the one on the phone. The speaker on the pen is used to provide audible feedback on functions initiated from the pen, such as tones or voice to acknowledge voice commands. The speaker can also be used for voice calls in conjunction with the microphone. By clipping the pen to a shirt pocket, shirt collar, shoulder harness of a seatbelt, etc., one can use it as a hands-free device as an alternative to a headset. In this position it can also be used to sound the ringer and other notification sounds where it is more audible than the phone in the pocket. It would not necessarily be ideal for music, video, or game sounds where its quality and lack of stereo is no better than the internal speaker and where stereo headsets provide higher quality sound in a more private environment. It could however be used for listening to a brief soundbite, such as the sound of a video found on the internet, providing a more audible and private alternative to the internal speaker without the hassle of mounting and connecting a headset. One more function of the speaker is an audible locating guide. If the pen moves too far from the host device, the bluetooth signal strength drops. This triggers the pen to emit a sound from the speaker warning the user that the pen may be left behind and enabling one to easily locate it.

The indicator LED consists of a multicolor RGB (red green blue) LED. The red, green, and blue components can be varied in intensity to produce a variety of colors. The light emanates from a transparent band around the perimeter of the pen. The light color is controlled by software in the host device and transmitted to the pen via the bluetooth link. The light can be used for visual notification supplementing the audible notification of the speaker. Different events can flash the light in different patterns just as different sounds are used. Notifications include phone calls, text messages, alarms etc. The LED can also be used for locating the pen along with the sound.

The vibrator is of the type found in phones and game controllers. It consists of a motor rotating an eccentric weight, causing uneven centrifugal forces. Vibration is triggered from the host device via the bluetooth link and can use different patterns. The vibration is a third notification system in addition to the sound and LED. It can be used for all of the functions of those, including locating the pen. In addition, it can be used to provide haptic feedback in games similar to the vibration found in many game controllers.

The display may be an LCD or OLED display. It can display various information regarding the operation of the device. Text and graphics are sent from the host device via the bluetooth link. The display can provide more detailed feedback for operations performed from the pen than the LED without the user having to look at the host device screen. Information displayed may include name of caller or message sender, partial text of message, title of song playing, weather condition, time and date.

The temperature sensor is a thermistor located behind the pen tip. The voltage from it is converted to digital, then transmitted to the host device via the bluetooth link. It can be used to measure air temperature, without the influence of heat generated by the phone, and body temperature by placing it under the armpit.

This stylus device is multi-functional. It fits easily in its host device, is charged therein, and will significantly enhance the capabilities of mobile computing devices. It can be clipped to one's clothing and if not, it can easily be located if lost. It will become a must-have peripheral.

1. A multi-purpose peripheral device for use with mobile computers, including smartphones and tablet computers, comprising:
a. a pen-like shaft containing the remaining components
b. a stylus point for input to a touch-screen on the mobile computer
c. A camera on the reverse end of the shaft
d. a microprocessor to control the functions of the device
e. A bluetooth wireless interface inside the pen, to transfer data between the device and the mobile computer.
f. a battery to provide power for the components of the device.
g. one or more switches to operate the components of the device.
h. one or more LED indicator lights.

2. The device of claim 1, wherein the camera on the reverse end of the shaft is surrounded by a ring-light comprised of a transparent plastic waveguide with one or more LED's at its base.

3. The device of claim 2, wherein the stylus point is an active-digitizer stylus for use with active-digitizer touch-screens.

4. The device of claim 3, further including a secondary active-digitizer input device at the reverse end of the device, that can serve as an eraser or secondary penpoint, and that is integrated with the ring-light structure.

5. The device of claim 4, further including an accelerometer for sensing the position and/or movement of the device.

6. The device of claim 5, further including a speaker and microphone.

7. The device of claim 6, further including a temperature sensor.

8. The device of claim 7, further including a vibration device for tactile feedback to the user.

9. The device of claim 8, further including an LCD or OLED display.

10. The device of claim 9, but wherein one or more of the following components are omitted: eraser mechanism, accelerometer, speaker/microphone, temperature sensor, vibration device, display.
